(19) United States
(12) Patent Application Publication
(10) Pub. No.: US 2024/0307250 A1
(43) Pub. Date: Sep. 19, 2024

(54) HEAD MASSAGE APPARATUS

(71) Applicant: Natasha Granum, Loganville, GA (US)

(72) Inventor: Natasha Granum, Loganville, GA (US)

(21) Appl. No.: 18/122,426

(22) Filed: Mar. 16, 2023

(51) Int. Cl. A61H 7/00

(52) U.S. Cl. CPC A61H 7/004; A61H 2201/0207; A61H 2201/1215; A61H 2201/1607; A61H 2201/165; A61H 2201/1671; A61H 2201/5002; A61H 2201/5097; A61H 2205/028

(57) ABSTRACT

A head massage apparatus for massaging the head with massager elements positioned on the inside of a cap worn on the head includes a cap with a plurality of massagers for massaging a user's head. Each massager has a motor and an engagement member eccentrically mounted to the motor which is positioned to engage the head of the user. When activated, the motor moves the engagement member in a circular path along the head of the user to massage the head.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to head massagers and more particularly pertains to a new head massager for massaging the head with massager elements positioned on the inside of a cap worn on the head.

### (2) Description of Related Art including information disclosed under 37 CFR 1.97 and 1.98.

Several examples exist in the prior art of head massagers comprising a cap with massaging elements positioned on the cap for massaging a user's head. These devices typically include vibration motors or air cushions which inflate and deflate to massage the head. However, it is desirable to have a massager cap that massages the head by moving massaging elements along the head to stretch or knead the muscles and skin of the head more efficiently than vibrating or compressive alternatives. The prior art does not disclose a head massaging cap which incorporates such elements. The prior art also does not provide for a massaging cap which, in combination with moving massaging elements along the head, simultaneously heats the head and does not include a remote control for operation of the device.

### BRIEF SUMMARY OF THE INVENTION

An embodiment of the disclosure meets the needs presented above by generally comprising a cap having a dome shape, and an inner surface of the cap defines a cavity for receiving a head of a user. The cap is shaped such that a rim of the cap is configured for being positioned to surround the head of the user. A plurality of massagers is coupled to the cap and is distributed across the inner surface. Each massager of the plurality of massagers protruding inwardly with respect to the cap and comprises a motor and an engagement member. The engagement member of a respective massager of the plurality of massagers is eccentrically mounted to the motor of the respective massager such that the motor urges the engagement member to move in a circular path when the motor is activated. The motor of the respective massager is configured to urge the engagement member of the respective massager along the head of the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a head massage apparatus according to an embodiment of the disclosure.

FIG. 2 is a side in-use view of an embodiment of the disclosure.

FIG. 3 is a front view of an embodiment of the disclosure. FIG. 4 is a rear view of an embodiment of the disclosure.

FIG. 5 is a top view of an embodiment of the disclosure.

FIG. 6 is a bottom view of an embodiment of the disclosure.

FIG. 7 is an in-use view of an embodiment of the disclosure.

FIG. 8 is a block diagram of an embodiment of the disclosure.

### DETAILED DESCRIPTION OF THE INVENTION

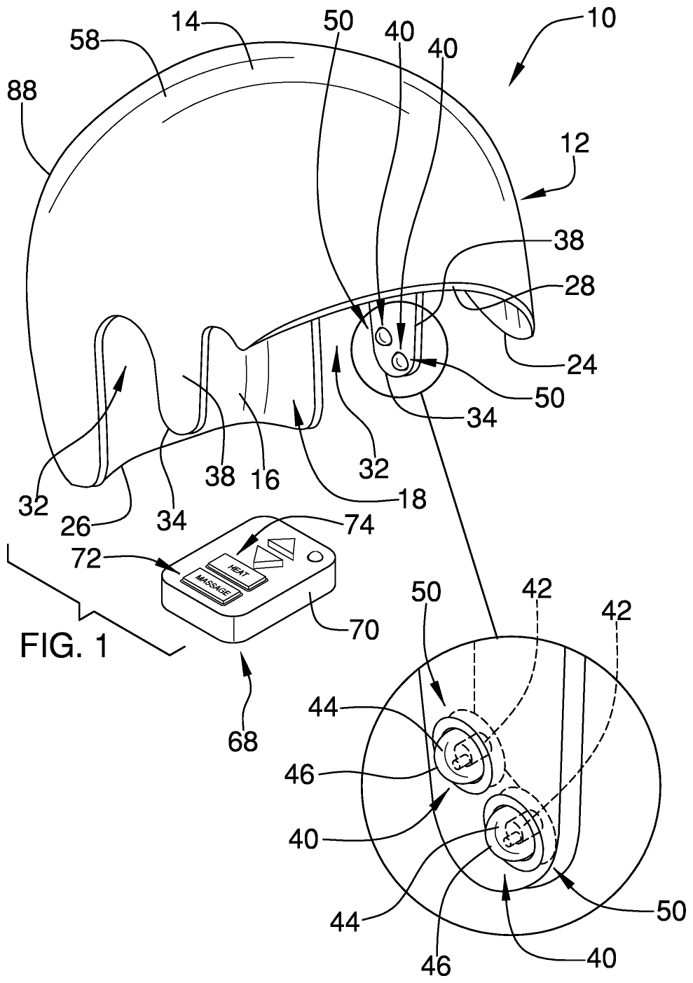

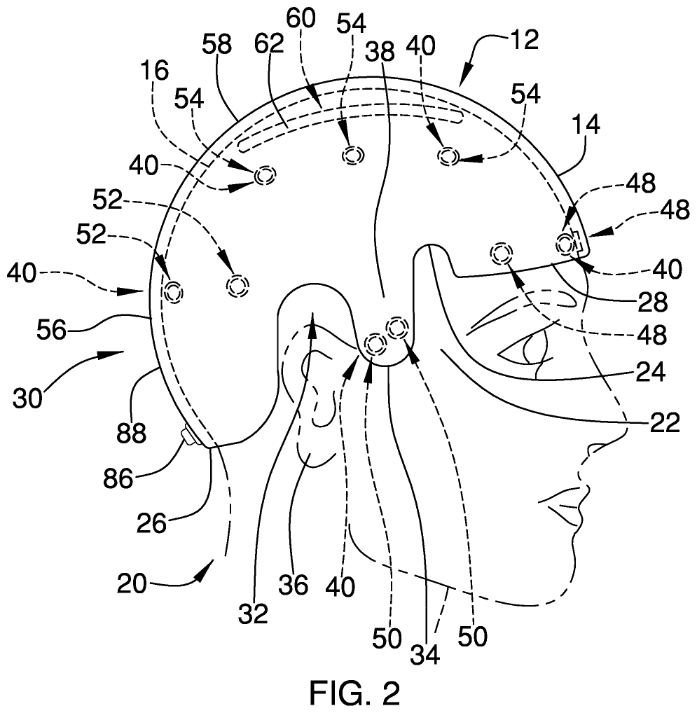

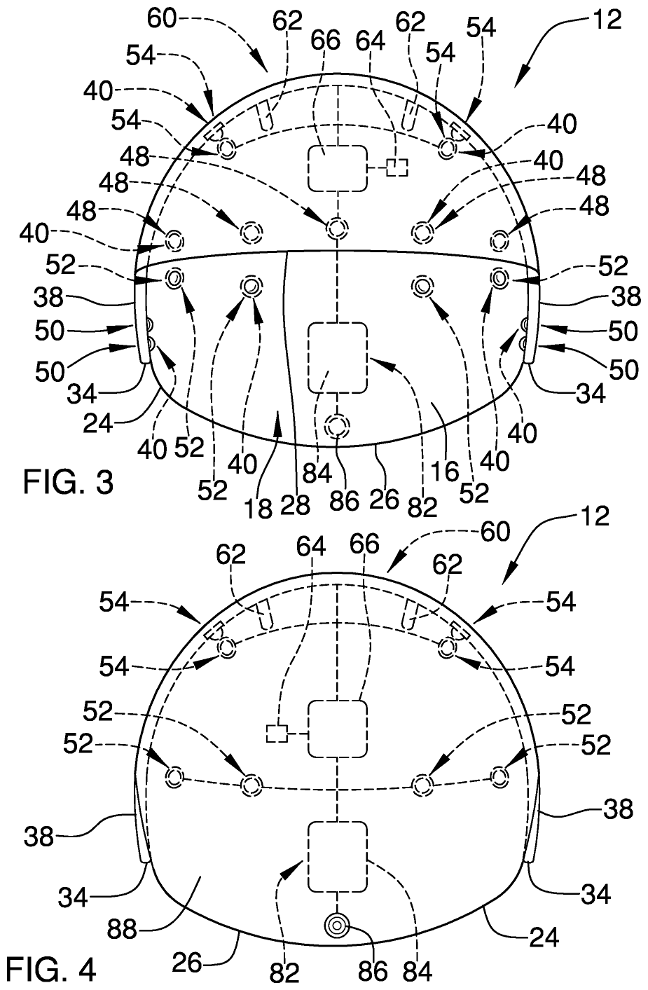

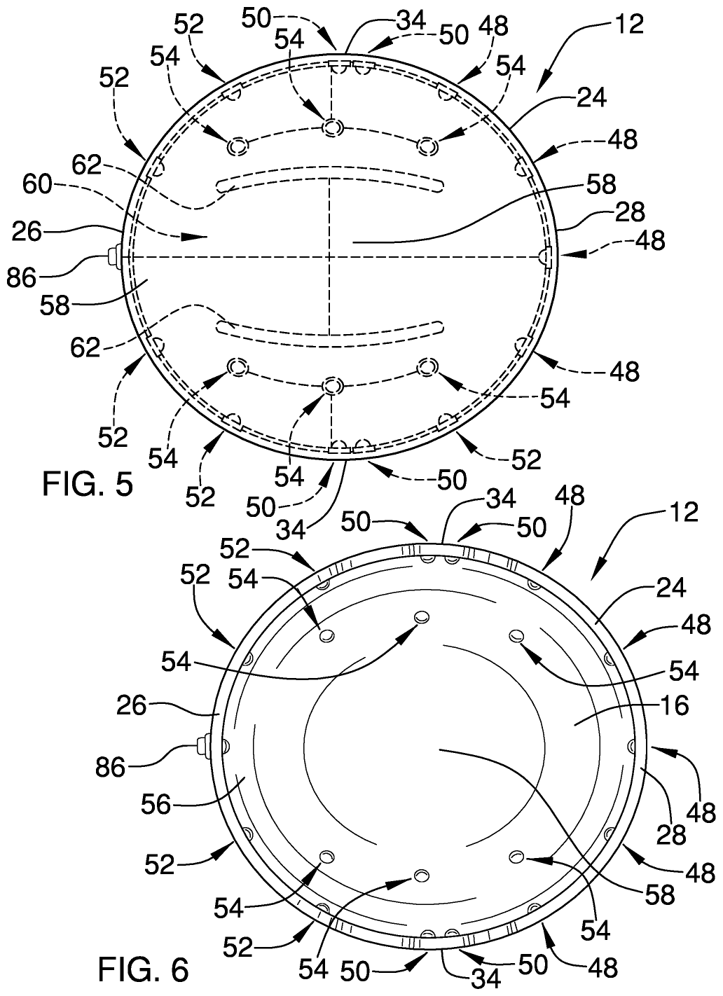

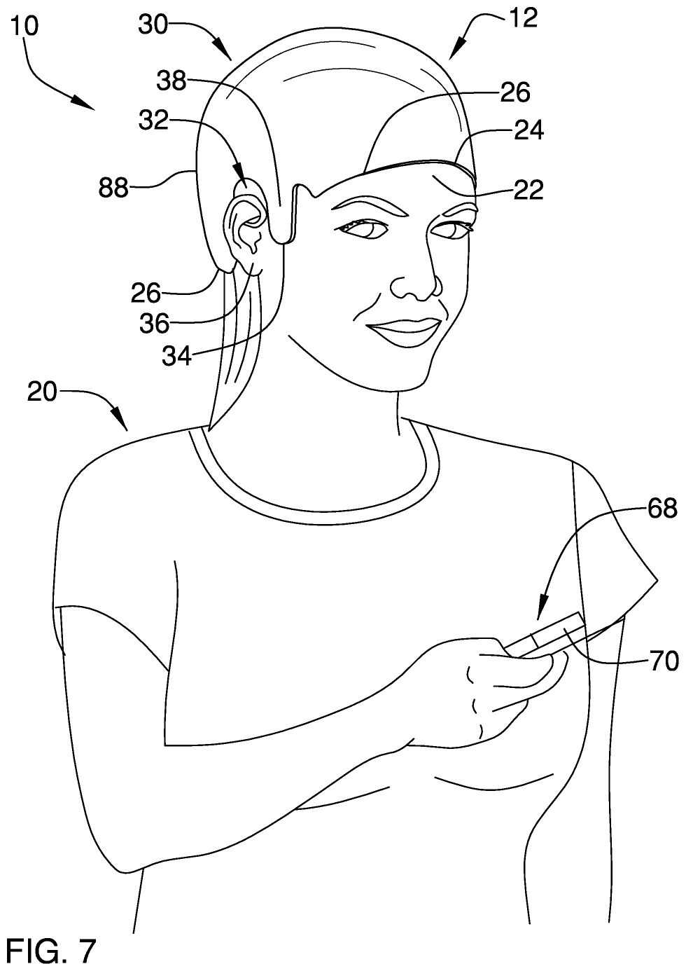

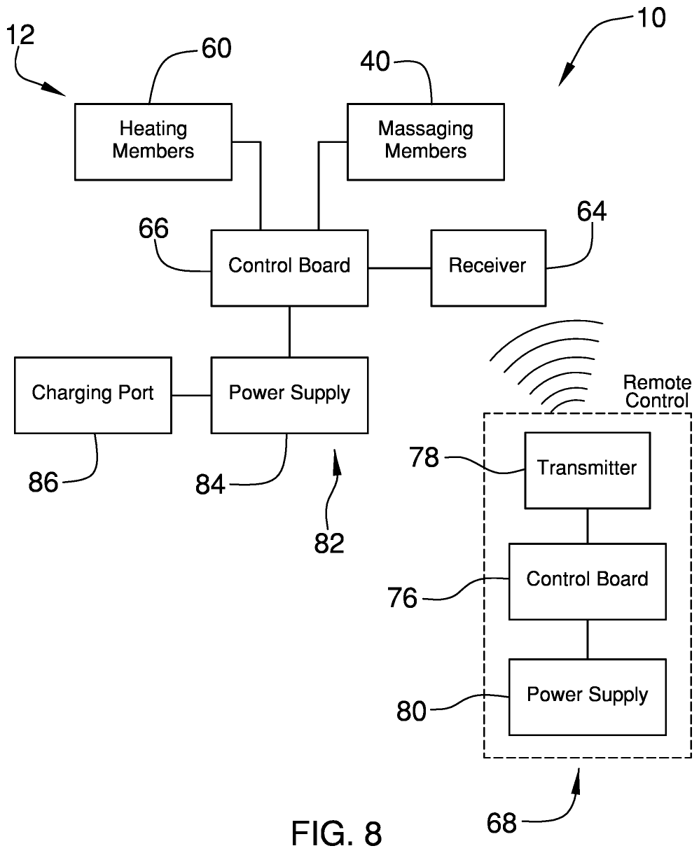

With reference now to the drawings, and in particular to FIGS. 1 through 8 thereof, a new head massager embodying the principles and concepts of an embodiment of the disclosure and generally designated by the reference numeral 10 will be described.

As best illustrated in FIGS. 1 through 8, the head massage apparatus 10 generally comprises a cap 12 having a dome shape 14, and an inner surface 16 of the cap 12 defines a cavity 18 for receiving a head 22 of a user 20. The cap 12 is shaped such that a rim 24 of the cap 12 is configured for being positioned to surround the head 22 of the user 20. The cap 12 is also elastically stretchable such that the cap 12 is configured to stretch around the head 22 of the user 20. The cap 12 may be constructed of an elastomer such as rubber, elastane, nylon, or the like. A rear portion 26 of the rim 24 is positioned lower than a front portion 28 of the rim 24 when the cap 12 is positioned in a use condition 30. The cap 12 has a pair of recesses 32 extending through the rim 24, and each recess 32 of the pair of recesses 32 is positioned on a respective one of a pair of lateral portions 34 of the rim 24. Each recess 32 of the pair of recesses 32 is configured for receiving a respective ear 36 of a pair of ears 36 of the user 20. The cap 12 has a pair of temple portions 38, each of which is positioned forwardly of a respective recess 32 of the pair of recesses 32 with respect to the cap 12.

A plurality of massagers 40 is coupled to the cap 12 and is distributed across the inner surface 16. Each massager 40 of the plurality of massagers 40 protrudes inwardly with respect to the cap 12 and comprises a motor 42 and an engagement member 44. The engagement member 44 of a respective massager 40 of the plurality of massagers 40 is eccentrically mounted to the motor 42 of the respective massager 40 such that the motor 42 urges the engagement member 44 to move in a circular path when the motor 42 is activated. The motor 42 of the respective massager 40 is configured to urge the engagement member 44 of the respective massager 40 along the head 22 of the user 20. The engagement member 44 of each massager 40 of the plurality of massagers 40 has a semispherical shape 46. The plurality of massagers 40 includes a group of front massagers 48, a group of temple massagers 50, a group of rear massagers 52, and a group of upper massagers 54. The group of front massagers 48 is positioned adjacent to the front portion 28 of the rim 24. Each temple massager 50 of the group of temple massagers 50 is positioned on an associated one of the pair of temple portions 38 of the cap 12. The group of rear massagers 52 is positioned on a rear segment 56 of the cap 12 and is spaced from the rear portion 26 of the rim 24. The group of upper massagers 54 is positioned on an upper segment 58 of the cap 12.

A heater 60 is coupled to the cap 12 and is positioned on the upper segment 58 of the cap 12. The heater 60 comprises a pair of laterally spaced heating elements 62. A massager control circuit 66 is operatively coupled to each massager 40 of the plurality of massagers 40 and the heater 60, and a receiver 64 is electrically coupled to the massager control circuit 66. A controller 68 is operatively coupled to the massager control circuit 66 and comprises a housing 70 that is hollow, a massage input 72, a heating input 74, a remote control circuit 76, a transmitter 78, and a remote power supply 80. The massage input 72 is mounted to the housing 70 and is actuatable to activate the motors 42 of the plurality of massagers 40 and select a speed of each massager 40 of the plurality of massagers 40. The heating input 74 is mounted to the housing 70 and is actuatable to activate the heater 60 and select a heat rate of the heater 60. The remote control circuit 76 is electrically coupled to the massage input 72 and the heating input 74, and the transmitter 78 is electrically coupled to the remote control circuit 76 for transmitting control signals to the receiver 64. The remote power supply 80 is electrically coupled to the remote control circuit 76

A massager power supply 82 is electrically coupled to the massager control circuit 66 and comprises a battery 84. A charging port 86 is electrically coupled to the battery 84. The charging port 86 is coupled to the cap 12 and is positioned on an outer surface 88 of the cap 12 adjacent to the rear portion 26 of the rim 24.

In use, the cap 12 is worn on the head 22 of the user 20 such that the cavity 18 receives the head 22 of the user 20. The cap 12 elastically stretches to accommodate the head 22 and urges the massagers 40 to exert a force on the head 22. The massage input 72 is actuated to activate the motors 42 of the massagers 40 at a speed selected by the user 20, which causes the engagement members 44 of the massagers 40 to massage the head 22 of the user 20. The heating input 74 is actuated to activate the heater 60 at a heat rate chosen by the user 20 to heat the head 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A head massage apparatus comprising:
a cap having a dome shape, an inner surface of said cap defining a cavity for receiving a head of a user, said cap being shaped such that a rim of said cap is configured for being positioned to surround the head of the user; and
a plurality of massagers being coupled to said cap, said plurality of massagers being distributed across said inner surface, each massager of said plurality of massagers protruding inwardly with respect to said cap, each massager of said plurality of massagers comprising a motor and an engagement member, said engagement member of a respective massager of said plurality of massagers being eccentrically mounted to said motor of said respective massager such that said motor urges said engagement member to move in a circular path when said motor is activated, said motor of said respective massager being configured to urge said engagement member of said respective massager along the head of the user.

2. The apparatus of claim 1, wherein said cap is elastically stretchable such that said cap is configured to stretch around the head of the user.

3. The apparatus of claim 1, wherein a rear portion of said rim is positioned lower than a front portion of said rim when said cap is positioned in a use condition, said cap having a pair of recesses extending through said rim, each recess of said pair of recesses being positioned on a respective one of a pair of lateral portions of said rim, each recess of said pair of recesses being configured for receiving a respective ear of a pair of ears of the user, said cap having a pair of temple portions, each temple portion of said pair of temple portions being positioned forwardly of a respective recess of said pair of recesses with respect to said cap.

4. The apparatus of claim 1, wherein said engagement member of each massager of said plurality of massagers has a semispherical shape.

5. The apparatus of claim 3, wherein said plurality of massagers includes:
a group of front massagers being positioned adjacent to said front portion of said rim;
a group of temple massagers, each temple massager of said group of temple massagers being positioned on an associated one of said pair of temple portions of said cap;
a group of rear massagers being positioned on a rear segment of said cap, said group of rear massagers being spaced from said rear portion of said rim; and
a group of upper massagers being positioned on an upper segment of said cap.

6. The apparatus of claim 1, further comprising a heater being coupled to said cap and being positioned on an upper segment of said cap.

7. The apparatus of claim 6, wherein said heater comprises a pair of laterally spaced heating elements.

8. The apparatus of claim 1, further comprising:
a massager control circuit being operatively coupled to each massager of said plurality of massagers; and
a controller being operatively coupled to said massager control circuit, said controller comprising a housing being hollow and a massage input being mounted to said housing, said massage input being actuatable to activate said motors of said plurality of massagers and select a speed of each massager of said plurality of massagers.

9. The apparatus of claim 8, further comprising:
a receiver being electrically coupled to said massager control circuit; and
said controller further comprising:
a remote control circuit being electrically coupled to said massage input and said heating input;
a transmitter being electrically coupled to said remote control circuit for transmitting control signals to said receiver; and
a remote power supply being electrically coupled to said remote control circuit.

10. The apparatus of claim 6, further comprising:
a massager control circuit being operatively coupled to each massager of said plurality of massagers and said heater;
a controller being operatively coupled to said massager control circuit, said controller comprising:
a housing being hollow;
a massage input being mounted to said housing, said massage input being actuatable to activate said motors of said plurality of massagers and select a speed of each massager of said plurality of massagers; and
a heating input being mounted to said housing, said heating input being actuatable to activate said heater and select a heat rate of said heater.

11. The apparatus of claim 10, further comprising:
a receiver being electrically coupled to said massager control circuit;
said controller further comprising:
a remote control circuit being electrically coupled to said massage input and said heating input;
a transmitter being electrically coupled to said remote control circuit for transmitting control signals to said receiver; and
a remote power supply being electrically coupled to said remote control circuit.

12. The apparatus of claim 1, further comprising a massager power supply being electrically coupled to said massager control circuit.

13. The apparatus of claim 12, wherein said massager power supply comprises a battery.

14. The apparatus of claim 13, further comprising a charging port being electrically coupled to said battery, said charging port being coupled to said cap and being positioned on an outer surface of said cap adjacent to said rear portion of said rim.

15. A head massage apparatus comprising:
a cap having a dome shape, an inner surface of said cap defining a cavity for receiving a head of a user, said cap being shaped such that a rim of said cap is configured for being positioned to surround the head of the user, said cap being elastically stretchable such that said cap is configured to stretch around the head of the user, a rear portion of said rim being positioned lower than a front portion of said rim when said cap is positioned in a use condition, said cap having a pair of recesses extending through said rim, each recess of said pair of recesses being positioned on a respective one of a pair of lateral portions of said rim, each recess of said pair of recesses being configured for receiving a respective ear of a pair of ears of the user, said cap having a pair of temple portions, each temple portion of said pair of temple portions being positioned forwardly of a respective recess of said pair of recesses with respect to said cap;
a plurality of massagers being coupled to said cap, said plurality of massagers being distributed across said inner surface, each massager of said plurality of massagers protruding inwardly with respect to said cap, each massager of said plurality of massagers comprising a motor and an engagement member, said engagement member of a respective massager of said plurality of massagers being eccentrically mounted to said motor of said respective massager such that said motor urges said engagement member to move in a circular path when said motor is activated, said motor of said respective massager being configured to urge said engagement member of said respective massager along the head of the user, said engagement member of each massager of said plurality of massagers having a semispherical shape, said plurality of massagers including:
a group of front massagers being positioned adjacent to said front portion of said rim;
a group of temple massagers, each temple massager of said group of temple massagers being positioned on an associated one of said pair of temple portions of said cap;
a group of rear massagers being positioned on a rear segment of said cap, said group of rear massagers being spaced from said rear portion of said rim; and
a group of upper massagers being positioned on an upper segment of said cap;
a heater being coupled to said cap and being positioned on said upper segment of said cap, said heater comprising a pair of laterally spaced heating elements;
a massager control circuit being operatively coupled to each massager of said plurality of massagers and said heater;
a receiver being electrically coupled to said massager control circuit;
a controller being operatively coupled to said massager control circuit, said controller comprising:
a housing being hollow;
a massage input being mounted to said housing, said massage input being actuatable to activate said motors of said plurality of massagers and select a speed of each massager of said plurality of massagers;
a heating input being mounted to said housing, said heating input being actuatable to activate said heater and select a heat rate of said heater;
a remote control circuit being electrically coupled to said massage input and said heating input;
a transmitter being electrically coupled to said remote control circuit for transmitting control signals to said receiver; and
a remote power supply being electrically coupled to said remote control circuit;
a massager power supply being electrically coupled to said massager control circuit, said massager power supply comprising a battery; and
a charging port being electrically coupled to said battery, said charging port being coupled to said cap and being positioned on an outer surface of said cap adjacent to said rear portion of said rim.
